(19) United States
(12) Patent Application Publication
(10) Pub. No.: US 2016/0097348 A1
(43) Pub. Date: Apr. 7, 2016

(54) VEHICLE

(71) Applicant: GM Global Technology Operations LLC, Detroit, MI (US)

(72) Inventors: Mahmoud H. Abd Elhamid, Troy, MI (US); Anne M. Dailly, West Bloomfield, MI (US); Mei Cai, Bloomfield Hills, MI (US); Arianna T. Morales, Royal Oak, MI (US)

(21) Appl. No.: 14/506,303

(22) Filed: Oct. 3, 2014

(51) Int. Cl. F02M 21/02; F02B 43/10; F02D 41/00; F02B 43/04

(52) U.S. Cl. CPC F02M 21/0221; F02B 43/04; F02B 43/10; F02M 21/0248; F02D 41/0027; F02B 2043/103

(57) ABSTRACT

A vehicle includes an internal combustion engine (ICE) to provide motive power to the vehicle. The ICE includes a pressurizable tank defining a tank volume to contain a solution of a natural gas and a liquid fuel. The ICE has a refueling port in fluid communication with the tank volume to selectably interface with a refueling nozzle to receive the solution from the refueling nozzle. A fuel supply tube conveys the solution from the pressurizable tank to the ICE. A fuel injector is in fluid communication with the fuel supply tube and a combustion chamber of the ICE. In response to a level of the solution in the pressurizable tank, the fuel injector is to selectably inject a predetermined quantity of the solution or a predetermined quantity of a gaseous mixture into the ICE for combustion. The gaseous mixture includes a vapor and the natural gas evaporated from the solution.

### BACKGROUND

Some internal combustion engines (ICEs) are designed to operate on a particular fuel. For example, an ICE may be designed to operate on regular unleaded gasoline with an Octane Rating of 87, or diesel grade 1-D. ICEs in flex fuel vehicles run on gasoline or gasoline-ethanol blends of up to 85% ethanol (E85).

Multi-fuel engines are capable of operating on multiple fuel types. For example, bi-fuel engines are capable of operating on two different fuel types. One fuel type may be a liquid phase fuel including gasoline, ethanol, bio-diesel, diesel fuel or combinations thereof that are delivered to the bi-fuel engine substantially in a liquid state. The other fuel type may include an alternative fuel, e.g., Compressed Natural Gas (CNG), Liquefied Petroleum Gas (LPG), hydrogen, etc. The two different fuels are stored in separate tanks, and the bi-fuel engine may run on one fuel at a time, or may alternatively run on a combination of the two different fuel types.

### SUMMARY

A vehicle includes an internal combustion engine (ICE) to provide motive power to the vehicle. The ICE includes a tank defining a tank volume to contain a solution of a natural gas and a liquid fuel. The ICE has a refueling port in fluid communication with the pressurizable tank volume to selectably interface with a refueling nozzle to receive the solution from the refueling nozzle. A fuel supply tube conveys the solution from the pressurizable tank to the ICE. A fuel injector is in fluid communication with the fuel supply tube and a combustion chamber of the ICE. In response to a level of the solution in the pressurizable tank, the fuel injector is to selectably inject a predetermined quantity of the solution or a predetermined quantity of a gaseous mixture into the internal combustion engine for combustion. The gaseous mixture includes a vapor and the natural gas evaporated from the solution.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a system block diagram depicting an example of a vehicle according to the present disclosure; and

FIG. 2 is a system block diagram depicting another example of a vehicle according to the present disclosure.

### DETAILED DESCRIPTION

Internal combustion engines (ICEs) combust fuel inside an engine to perform work. Some ICEs are used in vehicles to provide motive power to the vehicles. As used herein, vehicle means a self-propelled mobile machine that transports passengers or cargo. Examples of vehicles according to the present disclosure are: motor vehicles (motorcycles, cars, trucks, buses, trains), and watercraft (ships, boats).

In some cases, ICEs are defined by the type of fuel that the ICEs are designed to consume. For example, some diesel engines may run on diesel grade 1-D, or diesel grade 2-D. Gasoline engines may typically run on gasoline. Bi-fuel engines may be compatible with two types of fuel, for example, gasoline and natural gas. Flex-fuel vehicles (FFVs) may run on a range of combinations of gasoline and ethanol.

In examples of the present disclosure, a natural gas solute may be dissolved in a liquid fuel solvent. The solution of the natural gas solute in the liquid fuel solvent has more energy per volume than the liquid solvent fuel alone. For example, the energy available in a gallon of gasoline may be increased by dissolving natural gas in the gasoline. The solution of natural gas and gasoline does not increase the volume of the gasoline substantially; however, the energy density of the solution is greater than the energy density of the gasoline.

Some existing bi-fuel vehicles have a tank for storing natural gas and a separate tank for storing liquid fuel. In sharp contrast, examples of the vehicle of the present disclosure store the natural gas and the liquid fuel in the same pressurizable tank. In examples of the present disclosure, natural gas is stored in the pressurizable tank in two ways. First, the natural gas is dissolved, or absorbed, in the liquid fuel stored in the pressurizable tank. The amount of natural gas stored in the liquid fuel depends on the temperature of the solution and the pressure in the pressurizable tank. In examples of the present disclosure, a mass fraction of the natural gas in the solution ranges from about 2 percent by weight (% wt) to about 20% wt.

The second way that the natural gas is stored in the pressurizable tank is as a gas in the ullage space. It is to be understood that none of the fuels disclosed herein are in a supercritical state in the pressurizable tank. Therefore, the gas will rise above a surface of the liquid in the tank. As used herein, the ullage space is the volume in the pressurizable tank that is not occupied by the liquid. Also as used herein, the ullage space increases in volume as the volume of the liquid in the pressurizable tank decreases. The natural gas in the ullage space will reach an equilibrium pressure equal to the vapor pressure of the natural gas dissolved in the solution. Since natural gas is a mixture of constituent gases, each of the constituent gases will tend toward an equilibrium partial pressure equal to the partial vapor pressure of the constituent dissolved in the solution. As used herein, the partial pressure of the natural gas means the sum of the partial pressures of each of the constituent gases in the natural gas. It is to be understood that the liquid fuel may also have volatile components with vapor pressures. The total pressure in the ullage space of the tank is the sum of the partial pressures of all of the gases in the ullage space.

ASTM International, known until 2001 as the American Society for Testing and Materials (ASTM), is an international standards organization that develops and publishes voluntary consensus technical standards for a wide range of materials, products, systems, and services. One method of measuring vapor pressure is by the test method ASTM-D-323, which determines Reid Vapor Pressure (RVP). RVP is a measure of the volatility of volatile crude oil and volatile nonviscous petroleum liquids, except liquefied petroleum gases. It is defined as the absolute vapor pressure exerted by a liquid at 100° F. (37.8° C.) as determined by the test method ASTM-D-323.

It is to be understood that the liquid fuel in examples of the present disclosure is not limited to petroleum liquid fuel. The liquid fuel may include, for example, biodiesel or bio-ethanol or other alcohols. Although ethanol may be produced from petroleum (by hydrolysis of ethylene), most ethanol is produced from agricultural products. As such, ethanol may be a petroleum liquid fuel or a non-petroleum liquid fuel. Biodiesel is produced from agricultural products. Petroleum liquid fuels include gasoline, kerosene, diesel fuel and other similar liquid fuels.

SAE International, initially established as the Society of Automotive Engineers (SAE), is a U.S.-based, globally active professional association and standards organization for engineering professionals in various industries.

According to SAE Surface Vehicle Standard J313, Diesel Fuels, Jul. 28, 2008, automotive and railroad diesel fuels, in general, are derived from petroleum refinery products which are commonly referred to as middle distillates. Middle distillates represent products which have a higher boiling range than gasoline and are obtained from fractional distillation of the crude oil or from streams from other refining processes. Finished diesel fuels represent blends of middle distillates. The properties of commercial distillate diesel fuels depend on the refinery practices employed and the nature of the crude oils from which they are derived. Thus, they may differ both with and within the region in which they are manufactured. Such fuels generally boil over a range between 163° C. and 371° C. (325° F. to 700° F.). Their makeup can represent various combinations of volatility, ignition quality, viscosity, sulfur level, gravity, and other characteristics. Additives may be used to impart special properties to the finished diesel fuel.

ASTM D 975 includes five grades of diesel fuel: Grade No. 1-D; Grade Low Sulfur No. 1-D; Grade No. 2-D; Grade Low Sulfur No. 2-D; and Grade 4-D.

SAE Surface Vehicle Recommended Practice J312, Automotive Gasolines, Feb. 1, 2001, summarizes the composition of automotive gasolines, the significance of their physical and chemical characteristics, and the pertinent test methods for defining or evaluating these properties.

As used herein, liquid fuels are fuels that are generally in a liquid phase at standard ambient temperature 25° C. and pressure (100 kPa absolute). It is to be understood that even though liquid fuels are generally in the liquid phase, the liquid fuels may be volatile, and may completely evaporate if left in an open container for a certain amount of time. As used herein, liquid fuels have boiling points that are higher than 25° C. It is to be understood that some liquid fuels are blends of a plurality of component liquid fuels.

SAE Surface Vehicle Recommended Practice J1616, Recommended Practice for Compressed Natural Gas Vehicle Fuel, Issued February 1994, describes natural gas as follows: Natural gas is comprised chiefly of methane (generally 88 to 96 mole percent) with the balance being a decreasing proportion of non-methane alkanes (i.e., ethane, propane, butanes, etc.). Other components found in natural gas are nitrogen (N₂), carbon dioxide (CO₂), water, oxygen, and trace amounts of lubricating oil (from compressors) and sulfur found as hydrogen sulfide (H₂S) and other sulfur compounds. Before entering the commercial natural gas transmission system, natural gas is processed to meet limits on hydrogen sulfide, water, condensables of heavier hydrocarbons, inert gases such as CO₂ and N₂, and energy content. Mercaptan odorants (e.g., tertiary butyl mercaptan) are added by local distribution companies (LDC's) to add a human-detectable odor to natural gas which otherwise would be odorless.

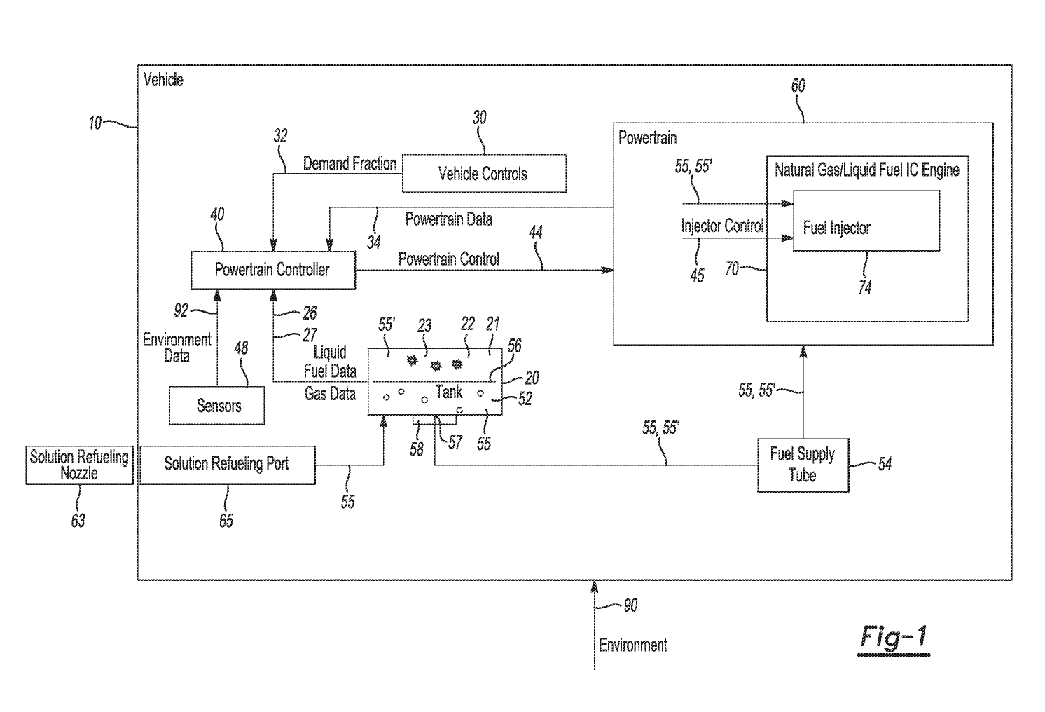

FIG. 1 is a system block diagram depicting an example of a vehicle 10 having a powertrain 60 with a natural gas and liquid fueled internal combustion engine (ICE) 70 to provide motive power to the vehicle 10. The vehicle 10 is depicted in an environment 90. The vehicle 10 has sensors 48 that provide environmental data 92 to the powertrain controller 40. Examples of the environmental data 92 include ambient air pressure, temperature, and humidity. The vehicle 10 has a pressurizable tank 20 defining a tank volume 21 to contain a solution 55 of a natural gas 22 and liquid fuel 52. The pressurizable tank 20 sends the solution 55 to the powertrain 60. A fuel supply tube 54 is to convey the solution 55 from the pressurizable tank 20 to the ICE 70. Gas Data 26 about the natural gas 22 in the pressurizable tank 20 is sent to the powertrain controller 40. Liquid fuel data 27 about the liquid fuel 52 in the pressurizable tank 20 (for example, fuel level) is sent to the powertrain controller 40. The powertrain 60 sends powertrain data 34 to the powertrain controller 40. Examples of powertrain data 34 include any data from the ICE 70 used to control the ICE 70. For example, engine speed and temperature may be powertrain data 34. The powertrain 60 includes the natural gas and liquid fueled ICE 70. The ICE 70 depicted in FIG. 1 has a fuel injector 74 in fluid communication with the fuel supply tube 54 and a combustion chamber of the ICE 70. In response to a level of the solution 55 in the tank 20, the fuel injector 74 is to selectably inject a predetermined quantity of the solution 55 or a predetermined quantity of a gaseous mixture 55′ of a vapor and the natural gas evaporated from the solution 55 into the ICE 70 for combustion in the ICE 70. In an example, the solution 55 and the gaseous mixture 55′ may be withdrawn from the pressurizable tank 20 via a tank port 57 positioned in a sump 58 of the pressurizable tank 20. The sump 58 is defined at the lowest part of the pressurizable tank 20 where the solution 55 will collect under the influence of gravity. When a minimum volume of the solution 55 is in the pressurizable tank 20, the tank port 57 will be submerged below a surface 56 of the solution 55. When the tank port 57 is submerged, the gaseous mixture 55′ is prevented from being withdrawn through the tank port 57 until the solution 55 has been depleted to expose the tank port 57 to the gaseous mixture 55′ above the surface 56 of the solution 55. The powertrain controller 40 sends the powertrain control 44 to inject the solution 55 or the gaseous mixture 55′ into the ICE 70 at a predetermined rate. The powertrain control 44 includes the injector control 45. The vehicle controls 30 provide the demand fraction 32 to the powertrain controller 40. For example, the vehicle controls 30 may include an accelerator pedal (not shown), and the demand fraction 32 may be a fraction of the power capability of the ICE 70. For example, fully actuating the accelerator pedal may indicate a 100 percent demand fraction 32. A solution refueling port 65 is in fluid communication with the tank volume 21 to selectably interface with a solution refueling nozzle 63 to receive the solution 55 from the solution refueling nozzle 63.

An example of operation of the vehicle 10 depicted in FIG. 1 is as follows: The solution 55 is delivered from the solution refueling nozzle 63 having a predetermined mass fraction of natural gas 22 between 2% wt and 20% wt. The solution 55 may be under pressure and may be chilled below ambient temperature to reduce the pressure associated with the predetermined mass fraction at the time of delivery. The natural gas 22 will evaporate to the ullage space 23 until the vapor pressure of the natural gas 22 reaches equilibrium with the partial pressure of the natural gas 22 in the pressurizable tank 20. The volatile components of the liquid fuel 52 will also evaporate into the ullage space 23 until an equilibrium pressure is reached. The total pressure in the pressurizable tank 20 will be the sum of the partial pressure of the natural gas 22 and the partial pressure of the vapor from the liquid fuel 52 plus the partial pressure from any other gases that may be present in the pressurizable tank 20 (for example, air or water vapor). The solution 55 may be conveyed to the powertrain 60 to fuel the ICE 70. There may be sufficient pressure in the pressurizable tank 20 such that a pump is not required to cause a sufficient flow of the solution 55 to the ICE 70. In such a case, a regulator valve (not shown) may be used to control the flow and pressure of the solution 55 in the fuel supply tube 54. As the solution 55 is consumed in the pressurizable tank 20, the liquid level will drop, and the mass of the natural gas 22 in the ullage space 23 above the solution 55 will increase to maintain an equilibrium between the vapor pressure of the natural gas 22 in the solution 55 and the partial pressure of the natural gas in the ullage space 23. The total pressure in the tank may drop. The solution 55 in the pressurizable tank 20 may be depleted; however, a pressurized quantity of natural gas 22 and vapor from the liquid fuel 52 will remain in the tank. The ICE 70 may be capable of running on the gaseous mixture 55′ of natural gas 22 and vapor from the liquid fuel until the pressure becomes too low to meet the demand fraction 32. A pump may be used to boost the pressure of the gaseous mixture 55′ of natural gas 22 and vapor from the liquid fuel 52 for conveying the gaseous mixture 55′ to the ICE 70. As described above, the range of the vehicle 10 will be improved for a given tank capacity and amount of the liquid fuel 52 in a tank because, in addition to the liquid fuel 52, the natural gas 22 added to the tank is a source of additional energy to fuel the ICE 70.

The vehicle 10 may be refueled at any time; however, if there is pressure in the pressurizable tank 20, the pressure may be relieved prior to refueling. For example, the refueling station may have a vapor recovery system to recover the gaseous mixture 55′ that may be discharged from the pressurizable tank 20 to relieve the pressure. During refueling, the solution 55 may be transferred into the pressurizable tank 20 from the solution refueling nozzle 63. A predetermined volume of the solution 55 in the pressurizable tank 20 less than a capacity of the tank volume 21 triggers the solution refueling port 65 to close and stops the transfer of the solution 55 into the pressurizable tank 20. As used herein, the capacity of the tank volume 21 is the spatial volume of the tank volume 21.

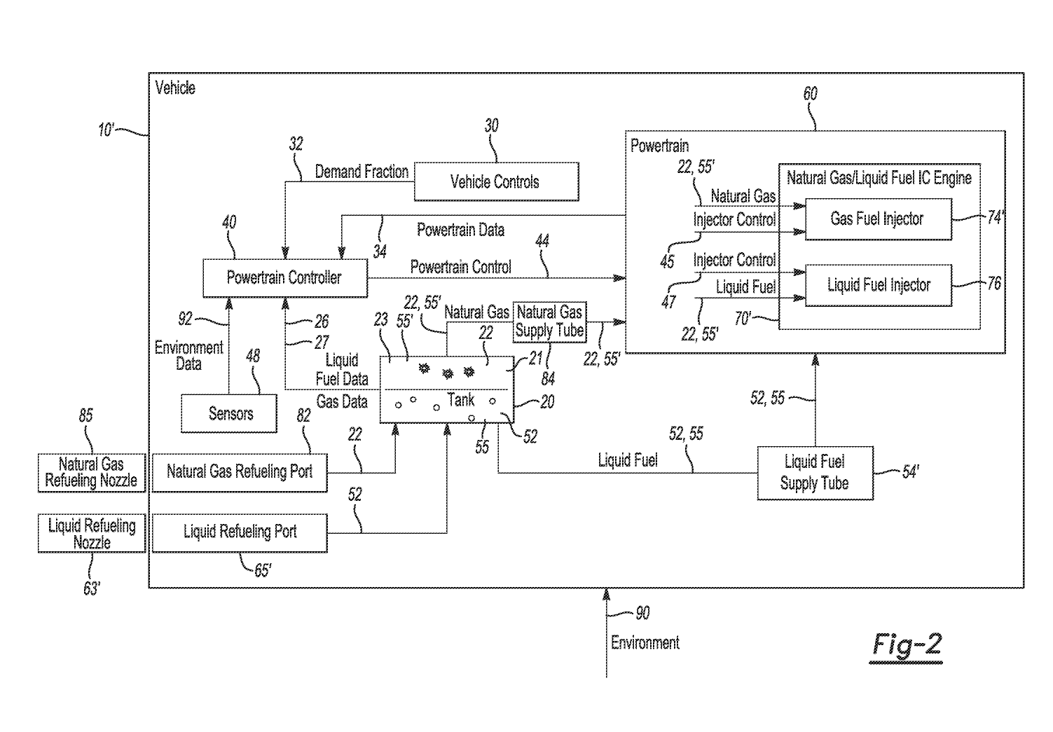

FIG. 2 is a system block diagram depicting an example of a vehicle 10′ having a powertrain 60 with a natural gas and liquid fueled internal combustion engine (ICE) 70′ to provide motive power to the vehicle 10′. The vehicle 10′ is depicted in an environment 90. The vehicle 10′ has sensors 48 that provide environmental data 92 to the powertrain controller 40. Examples of the environmental data 92 include ambient air pressure, temperature, and humidity. The vehicle 10′ has a pressurizable tank 20 defining a tank volume 21 to contain a solution 55 of a natural gas 22 and liquid fuel 52. A natural gas fuel supply tube 84 is to convey the natural gas 22 from the tank to the ICE 70′. A liquid fuel supply tube 54′ is to convey the liquid fuel 52 from the pressurizable tank 20 to the ICE 70′.

Vapor evaporated from the liquid fuel 52 may mix with the natural gas 22 in the ullage space 23. The vehicle 10′ of the present disclosure does not separate the natural gas 22 from the mixture 55′ of the vapor and the natural gas 22. Thus, when the natural gas 22 is conveyed through the natural gas fuel supply tube 84, the natural gas 22 may be mixed with the vapor evaporated from the liquid fuel 52. Similarly, natural gas 22 from the ullage space 23 may dissolve in the liquid fuel 52 to form a solution 55 of natural gas 22 solute and liquid fuel 52 solvent. Thus, when the liquid fuel 52 is conveyed through the liquid fuel supply tube 54′, natural gas 22 may be dissolved in the liquid fuel 52, and the liquid fuel 52 conveyed in the liquid fuel supply tube 54 may be conveyed in the solution 55. Gas Data 26 about the natural gas 22 in the pressurizable tank 20 is sent to the powertrain controller 40. Liquid fuel data 27 about the liquid fuel 52 in the pressurizable tank 20 (for example, fuel level) is sent to the powertrain controller 40. The powertrain 60 sends powertrain data 34 to the powertrain controller 40. Examples of powertrain data 34 include any data from the engine used to control the ICE 70′. For example, engine speed and temperature may be powertrain data 34. The powertrain 60 includes the natural gas and liquid fueled ICE 70′. The ICE 70′ depicted in FIG. 2 has a liquid fuel injector 76 in fluid communication with the liquid fuel supply tube 54′ and a combustion chamber of the ICE 70′ to selectably inject a predetermined quantity of the liquid fuel 52 into a combustion chamber or an intake manifold for combustion in the ICE 70′. The ICE 70′ depicted in FIG. 2 also has a natural gas fuel injector 74′ in fluid communication with the natural gas fuel supply tube 84 and a combustion chamber of the ICE 70′ to selectably inject a predetermined quantity of the natural gas 22 into a combustion chamber or an intake manifold for combustion in the ICE 70′.

The liquid fuel injector 76 is to selectably inject a predetermined quantity of the liquid fuel 52 or a predetermined quantity of the solution 55 of natural gas 22 solute and liquid fuel 52 solvent into the ICE 70′ for combustion in the ICE 70′. The natural gas fuel injector 74′ is to selectably inject a predetermined quantity of the natural gas 22 or the gaseous mixture 55′ into the ICE 70′ for combustion in the ICE 70′. The powertrain controller 40 sends the powertrain control 44 to inject the liquid fuel 52, the solution 55, the natural gas 22, or the gaseous mixture 55′ into the ICE 70′ at a predetermined rate. The powertrain control 44 includes the injector control 45 to control the gas fuel injector 74′; and another injector control 47 to control the liquid fuel injector 76. The vehicle controls 30 provide the demand fraction 32 to the powertrain controller 40. A liquid refueling port 65′ is in fluid communication with the tank volume 21 to selectably interface with a liquid refueling nozzle 63′ to receive the liquid fuel 52 from liquid refueling nozzle 63′. A natural gas refueling port 82 is in fluid communication with the tank volume 21 to selectably interface with a natural gas refueling nozzle 85 to receive the natural gas 22 from the natural gas refueling nozzle 85.

The ICE 70′ may be to combust the liquid fuel 52 and the natural gas 22 in separate instances of a combustion cycle. In an example, the vehicle 10′ may generally use the natural gas 22 as the primary fuel for the vehicle 10′. In the example, the liquid fuel 52 is primarily an absorbent for storage of the natural gas 22, however, the liquid fuel 52 may serve as a reserve fuel to extend the range of the vehicle 10′ beyond the range of the vehicle 10′ operating on the natural gas 22. As stated above, the natural gas 22 may have some vapor from the liquid fuel 52 evaporated into the natural gas 22 to form the gaseous mixture 55′. The vehicle 10′ may be refueled with natural gas 22 at relatively low pressure, for example using a home refueling station up to 50 bar, and have enough range on the natural gas 22 for typical daily usage (e.g. about 40 miles). However, if additional range is required, the liquid fuel 52 may be used to fuel the ICE 70′. In another example, the natural gas 22 and the liquid fuel 52 may be co-injected into the ICE 70′ to be consumed together in the same combustion cycle of the ICE 70′. A combustion cycle is a cyclical series of stages of operation of an internal combustion engine. For example, gasoline engines commonly have a four-stroke combustion cycle having an intake, compression, power, and exhaust stroke of a piston repeated every two revolutions of the crankshaft. A two-stroke engine is a type of internal combustion engine which completes a power cycle (combustion cycle) in only one crankshaft revolution and with two strokes of the piston. The timing and location of the fuel injection is to be compatible with the operation of the engine.

The location for injection of the gaseous fuel and the liquid fuel into the ICE 70′ may depend on the type of ICE 70′. For example, the natural gas fuel injector 74′ and the liquid fuel injector 76 may each inject their respective fuel into an intake manifold of the ICE 70′ if the liquid fuel is gasoline and the ICE 70′ has spark ignition. Such an ICE 70′ may be capable of running separately on the natural gas 22, the gasoline, or a combination of both the natural gas 22 and the gasoline at the same time. In another example having a compression ignition ICE 70′ with natural gas and diesel fuel, the arrangement is different from the natural gas/gasoline/spark ignition combination. Without modification, compression ignition engines will not typically run on natural gas alone. A small amount of diesel fuel may be injected into the combustion chamber to ignite the natural gas. For example at least 20 to 30 percent of the normal mass of diesel fuel for a combustion cycle may be used to ignite the natural gas 22. The natural gas 22 may be injected in an intake manifold (not shown), or in the intake of a supercharger (not shown) or turbocharger (not shown).

An example of operation of the vehicle 10′ depicted in FIG. 2 is as follows: The liquid fuel 52 is delivered from the liquid refueling nozzle 63′ into the pressurizable tank 20. The liquid fuel 52 may be pressurized when delivered to overcome any pressure existing in the pressurizable tank 20 or developed in the pressurizable tank 20 during the delivery. In another example, the pressurizable tank 20 may be vented to depressurize the pressurizable tank and to allow refueling with a conventional liquid fuel dispensing nozzle. (See SAE Surface Vehicle Recommended Practice J285, Gasoline Dispenser Nozzle Spouts, Reaffirmed January 1999.) For example, an Onboard Refueling Vapor Recovery (ORVR) System may be used to capture the vented vapor from the pressurizable tank 20. The vapor may also be recovered at the refueling station using a refueling vapor recovery nozzle similar to a Stage II gasoline vapor recovery system nozzle.

Natural gas 22 may be delivered from the natural gas refueling nozzle 85 through the natural gas refueling port 82 to the pressurizable tank 20. The pressure may be relatively low, for example, from about 2 bar to about 50 bar. Some of the natural gas 22 that is introduced into the pressurizable tank 20 will dissolve in the liquid fuel 52 to form the solution 55. The portion of the natural gas 22 that does not dissolve into the solution 55 will mix with the evaporated vapor from the liquid fuel 52 to form the gaseous mixture 55′ in the ullage space 23. The pressure in the pressurizable tank 20 will be the sum of the partial pressure of the natural gas 22 and the partial pressure of the vapor from the liquid fuel 52 plus the partial pressure from any other gases that may be present in the tank (for example, air or water vapor). The gaseous mixture 55′ including the natural gas 22 may be conveyed to the powertrain 60 to fuel the ICE 70′. There may be sufficient pressure in the pressurizable tank 20 such that a pump is not required to cause a sufficient flow of the gaseous mixture 55′ including the natural gas 22 to the ICE 70′. In such a case, a regulator valve may be used to control the flow and pressure of the gaseous mixture 55′ in the natural gas fuel supply tube 84. As the gaseous mixture 55′ including the natural gas is consumed from the pressurizable tank 20, more vapor and natural gas 22 will evaporate from the solution 55 until the natural gas 22 or the liquid fuel 52 is depleted. The natural gas 22 may be substantially depleted from the pressurizable tank 20; however, some liquid fuel 52 may remain in the pressurizable tank 20. The ICE 70′ may be capable of continuing to run on the liquid fuel 52 (i.e. the solution 55 may have most of the natural gas depleted from it) until the liquid level is empty. As described above, the range of the vehicle 10′ will be improved for a given tank capacity and liquid level in the tank because, in addition to the liquid fuel, the natural gas added to the pressurizable tank 20 is a source of additional energy to fuel the ICE 70′.

Alternatively, rather than prioritizing consumption of the natural gas 22, the vehicle 10′ may consume the solution 55 of the liquid fuel 52 with the natural gas 22 dissolved therein. For a given temperature, a higher natural gas partial pressure in the ullage space 23 will cause more of the natural gas 22 to dissolve in the liquid fuel 52. Therefore, prioritizing consumption of the solution 55 with more of the natural gas 22 dissolved therein will provide more vehicle range per gallon of the liquid fuel 52 compared to the liquid fuel 52 with less of the natural gas dissolved therein.

In another example, the gas data 26 and the liquid fuel data 27 may be used along with the powertrain data 34 by the powertrain controller 40 to prioritize the consumption of the gaseous mixture 55′ including the natural gas 22, and the solution 55 including the dissolved natural gas to deplete the solution 55 and the gaseous mixture 55′ at about the same time. In other words, the pressurizable tank 20 will run out of the liquid fuel 52 and the natural gas 22 at about the same time. Such a simultaneous depletion strategy may be particularly advantageous in a compression ignition engine that cannot operate on the natural gas 22 alone. In any of the combinations that consume all of the natural gas 22 and all of the liquid fuel 52, regardless of the order, the range of the vehicle 10′ will be maximized since all of the fuel energy will be used for combustion in the ICE 70′.

Another advantage of the vehicle 10′ disclosed above may be realized when the pressurizable tank 20 uses the liquid fuel 52 as storage media for natural gas 22 and therefore has fewer issues with thermal management during refueling as compared with high pressure (e.g., about 250 bar) compressed natural gas powered vehicles.

The vehicle 10′ may be refueled with natural gas 22 at any time via the natural gas refueling port 82. To refuel with the liquid fuel 52, pressure in the pressurizable tank 20 may be overcome by pressurizing the liquid fuel 52 as the liquid fuel 52 is pumped into the pressurizable tank 20. Alternatively, the pressure in the pressurizable tank 20 may be relieved prior to refueling with the liquid fuel 52. For example, the refueling station may have a vapor recovery system (not shown) to recover the vapor that may be discharged from the pressurizable tank 20 to relieve the pressure. A predetermined volume of the liquid fuel 52 in the pressurizable tank 20 less than a capacity of the tank volume 21 may trigger the liquid refueling port 65′ to close and stop the transfer of the liquid fuel 52 into the pressurizable tank 20.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range from about 2 bar to about 50 bar should be interpreted to include not only the explicitly recited limits of from about 2 bar to about 50 bar, but also to include individual values, such as 5 bar, 10 bar, 15 bar, etc., and sub-ranges, such as from about 10 bar to about 18 bar; from about 15 bar to about 19.5 bar, etc. Furthermore, when “about” is utilized to describe a value, this is meant to encompass minor variations (up to +/−5 bar) from the stated value.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

What is claimed is:

1. A vehicle, comprising:
an Internal Combustion Engine (ICE) to provide motive power to the vehicle;
a pressurizable tank defining a tank volume to contain a solution of a natural gas and a liquid fuel;
a refueling port in fluid communication with the tank volume to selectably interface with a refueling nozzle to receive the solution from the refueling nozzle;
a fuel supply tube to convey the solution from the tank to the ICE; and
a fuel injector in fluid communication with the fuel supply tube and a combustion chamber of the ICE, in response to a level of the solution in the tank, to selectably inject a predetermined quantity of the solution or a predetermined quantity of a gaseous mixture of a vapor and the natural gas evaporated from the solution into the ICE for combustion therein.

2. The vehicle as defined in claim 1 wherein a mass fraction of the natural gas in the solution is from about 2 percent by weight to about 20 percent by weight.

3. The vehicle as defined in claim 2 wherein a predetermined volume of the solution in the pressurizable tank less than a capacity of the tank volume triggers the refueling port to close.

4. The vehicle as defined in claim 1 wherein the liquid fuel includes a petroleum liquid fuel, a biodiesel, an alcohol, or combinations thereof.

5. A vehicle, comprising:
an internal combustion engine (ICE) to provide motive power to the vehicle by combustion of a liquid fuel and a natural gas;
a pressurizable tank defining a tank volume to contain a solution of the natural gas and the liquid fuel;
a liquid refueling port in fluid communication with the tank volume to selectably interface with a liquid refueling nozzle to receive the liquid fuel from the liquid refueling nozzle;
a natural gas refueling port in fluid communication with the tank volume to selectably interface with a natural gas refueling nozzle to receive the natural gas from the natural gas refueling nozzle;
a natural gas fuel supply tube to convey the natural gas from the pressurizable tank to the ICE;
a liquid fuel supply tube to convey the liquid fuel from the pressurizable tank to the ICE;
a natural gas fuel injector in fluid communication with the natural gas fuel supply tube and a combustion chamber of the ICE to selectably inject a predetermined quantity of the natural gas into a combustion chamber or an intake manifold for combustion in the ICE; and
a liquid fuel injector in fluid communication with the liquid fuel supply tube and a combustion chamber of the ICE to selectably inject a predetermined quantity of the liquid fuel into a combustion chamber or an intake manifold for combustion in the ICE.

6. The vehicle as defined in claim 5 wherein the ICE is to combust the liquid fuel and the natural gas in separate instances of a combustion cycle.

7. The vehicle as defined in claim 5 wherein the ICE is to combust the liquid fuel and the natural gas together in a same combustion cycle.

8. The vehicle as defined in claim 5 wherein the liquid fuel has the natural gas dissolved therein.

9. The vehicle as defined in claim 5 wherein the pressurizable tank is a single tank, to concurrently contain the natural gas and the liquid fuel in the same tank volume.

10. The vehicle as defined in claim 5 wherein the vehicle has a greater range when compared with an otherwise similar vehicle having the pressurizable tank filled with only natural gas to the same pressure, or filled with only the liquid fuel to the same volume of the liquid fuel.
